(19) United States
(12) Patent Application Publication
(10) Pub. No.: US 2026/0228108 A1
(43) Pub. Date: Aug. 6, 2026

(54) COMPLIANCE MONITORING TECHNIQUES FOR MULTIPLE APPLICATIONS

(71) Applicant: Ally Financial Inc., Detroit, MI (US)

(72) Inventors: Joynal Abedin, Warren, MI (US); William Aaron McDonald, Macomb, MI (US); Ramakrishna Kothur, Charlotte, NC (US)

(21) Appl. No.: 19/043,208

(22) Filed: Jan. 31, 2025

(51) Int. Cl. G06F 11/3604

(52) U.S. Cl. CPC G06F 11/3608

(57) ABSTRACT

Methods, systems, and devices for data and application management are described. A system may display, at a centralized user interface, a set of applications associated with one or more projects of an organization, where the set of applications each correspond to respective sets of code repositories. The centralized user interface may display, for each application of the set of applications, one or more sets of information associated with each application. The one or more sets of information may include standards and security compliance information such as security scan timestamp information, compliance status information, policy information, gating information, or any combination thereof, for each application of the set of applications. Using the centralized user interface, a user or an organization may concurrently monitor the set of applications for compliance based on the displayed one or more sets of information, and may initiate timely security scans based on the information.

### FIELD OF TECHNOLOGY

The present disclosure relates generally to data management, including techniques for compliance monitoring techniques for multiple applications.

### BACKGROUND

An organization may include multiple teams of engineers and developers that develop applications (e.g., computing applications and software related to financial institutions, user connectivity, user engagement, or the like) that support data storage and other implementations. In some aspects, a data management system (DMS) may be employed to manage data associated with such computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data management services for data of the one or more computing systems, and may comply with one or more data security standards. Improved data management and standards compliance may offer improved performance with respect to reliability, speed, efficiency, scalability, security, data safety, among other possible aspects of performance.

### SUMMARY

The systems, methods, and devices of this disclosure each have several innovative aspects, no single one of which is solely responsible for the desirable attributes disclosed herein.

A method by an apparatus is described. The method may include displaying, at a centralized user interface, a set of multiple applications associated with one or more projects of an organization, where the set of multiple applications correspond to a respective set of multiple code repositories, displaying, for each application of the set of multiple applications at the centralized user interface, one or more sets of information associated with each application, where the one or more sets of information include security scan timestamp information, compliance status information, policy information, gating information, or any combination thereof, for each application of the set of multiple applications, and concurrently monitoring the set of multiple applications for compliance based on the one or more sets of information.

An apparatus is described. The apparatus may include one or more memories storing processor executable code, and one or more processors coupled with the one or more memories. The one or more processors may individually or collectively be operable to execute the code to cause the apparatus to display, at a centralized user interface, a set of multiple applications associated with one or more projects of an organization, where the set of multiple applications correspond to a respective set of multiple code repositories, display, for each application of the set of multiple applications at the centralized user interface, one or more sets of information associated with each application, where the one or more sets of information include security scan timestamp information, compliance status information, policy information, gating information, or any combination thereof, for each application of the set of multiple applications, and concurrently monitor the set of multiple applications for compliance based on the one or more sets of information.

Another apparatus is described. The apparatus may include means for displaying, at a centralized user interface, a set of multiple applications associated with one or more projects of an organization, where the set of multiple applications correspond to a respective set of multiple code repositories, means for displaying, for each application of the set of multiple applications at the centralized user interface, one or more sets of information associated with each application, where the one or more sets of information include security scan timestamp information, compliance status information, policy information, gating information, or any combination thereof, for each application of the set of multiple applications, and means for concurrently monitoring the set of multiple applications for compliance based on the one or more sets of information.

A non-transitory computer-readable medium storing code is described. The code may include instructions executable by one or more processors to display, at a centralized user interface, a set of multiple applications associated with one or more projects of an organization, where the set of multiple applications correspond to a respective set of multiple code repositories, display, for each application of the set of multiple applications at the centralized user interface, one or more sets of information associated with each application, where the one or more sets of information include security scan timestamp information, compliance status information, policy information, gating information, or any combination thereof, for each application of the set of multiple applications, and concurrently monitor the set of multiple applications for compliance based on the one or more sets of information.

In some examples of the method, apparatus, and non-transitory computer-readable medium described herein, concurrently monitoring the set of multiple applications for compliance may include operations, features, means, or instructions for determining, in accordance with the one or more sets of information displayed at the centralized user interface, that one or more applications of the set of multiple applications may be out of compliance based on the security scan timestamp information indicating a last scan time that exceeds a security scan frequency threshold and triggering one or more remedial actions for the one or more applications based on determining that the one or more applications may be out of compliance.

In some examples of the method, apparatus, and non-transitory computer-readable medium described herein, triggering the one or more remedial actions for the one or more applications may include operations, features, means, or instructions for triggering a security scan for the one or more applications based on the last scan time exceeding the security scan frequency threshold.

In some examples of the method, apparatus, and non-transitory computer-readable medium described herein, concurrently monitoring the set of multiple applications for compliance may include operations, features, means, or instructions for determining, in accordance with the one or more sets of information displayed at the centralized user interface, that one or more applications of the set of multiple applications may be out of compliance based on the policy information indicating at least one policy violation; and triggering one or more remedial actions for the one or more applications based on determining that the one or more applications may be out of compliance.

In some examples of the method, apparatus, and non-transitory computer-readable medium described herein, triggering the one or more remedial actions for the one or more applications may include operations, features, means, or instructions for triggering a scan for the one or more applications based on the at least one policy violation.

In some examples of the method, apparatus, and non-transitory computer-readable medium described herein, concurrently monitoring the set of multiple applications for compliance may include operations, features, means, or instructions for determining, in accordance with the one or more sets of information displayed at the centralized user interface, that one or more applications of the set of multiple applications may be out of compliance and triggering an exception flow to bypass one or more remedial actions.

In some examples of the method, apparatus, and non-transitory computer-readable medium described herein, the exception flow expires after a threshold duration, after a threshold quantity of pipeline executions, after a user disables the exception flow, or any combination thereof.

Some examples of the method, apparatus, and non-transitory computer-readable medium described herein may further include operations, features, means, or instructions for scanning the respective set of multiple code repositories for data associated with the one or more sets of information, where the scanning occurs in accordance with a scanning interval.

In some examples of the method, apparatus, and non-transitory computer-readable medium described herein, the scanning interval includes a dynamically adjustable scanning interval or a fixed scanning interval.

In some examples of the method, apparatus, and non-transitory computer-readable medium described herein, the compliance status information includes information associated with a compliance policy of a pipeline, the compliance policy including one or more of a set of components approved for use in the pipeline, a set of pipeline-specific security scans to be executed, a threshold vulnerability metric indicative of one or more policy violations, a set of pipeline gating actions that may be based on development lifecycle stage of the pipeline, policy violations, or both, or a set of policy violation remediation deadlines associated with the compliance policy.

In some examples of the method, apparatus, and non-transitory computer-readable medium described herein, displaying the one or more sets of information associated with each application may include operations, features, means, or instructions for monitoring the respective set of multiple code repositories associated with the set of multiple applications and displaying the security scan timestamp information, the compliance status information, the policy information, the gating information, or any combination thereof, for each application of the set of multiple applications based on monitoring the respective set of multiple code repositories associated with the set of multiple applications.

In some examples of the method, apparatus, and non-transitory computer-readable medium described herein, the security scan timestamp information, the compliance status information, the policy information, the gating information, or any combination thereof, may be indicative of real-time data compiled for the security scan timestamp information, the compliance status information, the policy information, the gating information, or any combination thereof.

In some examples of the method, apparatus, and non-transitory computer-readable medium described herein, providing, via one or more input fields of the centralized user interface, one or more search inputs associated with one or more applications of the set of multiple applications and receiving, via the centralized user interface, a returned list of the one or more applications based on the one or more search inputs.

In some examples of the method, apparatus, and non-transitory computer-readable medium described herein, each application of the set of multiple applications may be associated with a respective application identifier displayed at the centralized user interface.

Some examples of the method, apparatus, and non-transitory computer-readable medium described herein may further include operations, features, means, or instructions for displaying, at the centralized user interface, a timestamp that indicates a time since the one or more sets of information were last updated.

Some examples of the method, apparatus, and non-transitory computer-readable medium described herein may further include operations, features, means, or instructions for communicating, by the centralized user interface, with an application programming interface to access a database associated with the set of multiple applications and the respective set of multiple code repositories.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 illustrates an example of a computing environment that supports compliance monitoring techniques for multiple applications in accordance with aspects of the present disclosure.

FIG. 2 shows an example of a user interface that supports compliance monitoring techniques for multiple applications in accordance with aspects of the present disclosure.

FIG. 3 shows an example of an application compliance monitoring flow that supports compliance monitoring techniques for multiple applications in accordance with aspects of the present disclosure.

FIG. 4 shows an example of a process flow that supports compliance monitoring techniques for multiple applications in accordance with aspects of the present disclosure.

FIG. 5 shows a block diagram of a system that supports compliance monitoring techniques for multiple applications in accordance with aspects of the present disclosure.

FIG. 6 shows a block diagram of a dashboard integration component that supports compliance monitoring techniques for multiple applications in accordance with aspects of the present disclosure.

FIG. 7 shows a diagram of a system including a device that supports compliance monitoring techniques for multiple applications in accordance with aspects of the present disclosure.

FIGS. 8 and 9 show flowcharts illustrating methods that support compliance monitoring techniques for multiple applications in accordance with aspects of the present disclosure.

### DETAILED DESCRIPTION

An organization may host, support, or run a set of applications, each of which may be subject to stringent security metrics and compliance checks to ensure that each of the applications is running according to the latest security standards. Some organizations may support a relatively large quantity of applications that may each need to be manually checked for compliance to one or more standards. In some cases, however, manually checking compliance for applications (and associated code repositories associated with each application) is both labor and time intensive, and may be inefficient for an organization. Additionally, or alternatively, manually checking applications and associated code may be relatively inaccurate and vulnerable to human error.

To increase the efficiency and accuracy in how an organization manages security scanning and other compliance-related checks for applications, the organization may utilize a centralized dashboard that automates the collection and presentation of security scan and gating information (e.g., information regarding whether a security check has failed, whether a warning or an alert is issued, or the like) for various applications. The centralized dashboard may link each code repository to a corresponding application and may provide details about code repository ownership, associated business units, and the level of security gating implemented for a given application. Additionally, a centralized user interface may display information on whether security scans are enabled for a code repository and timestamps of when such security scans were last conducted. In some aspects, the centralized dashboard may display comprehensive application security metrics so that applications may be monitored, scanned, and maintained in real time. The centralized dashboard may additionally, or alternatively, provide relatively increased visibility into the most up-to-date security status of one or multiple applications, which may allow an organization to have easier access to security information, and more effectively and promptly address any non-compliant applications, providing support for timely security scans and implementing consistent security gating measures for applications that are found to be non-compliant.

Aspects of the disclosure may be implemented to realize one or more potential advantages. For example, the centralization of compliance information to a single dashboard location may support efficiency and time savings, replacing time-intensive processes of gathering audit information across multiple different applications and different locations with a single location, while enabling on-demand compliance status checks for all applications. Additionally, or alternatively, the implementation of a compliance dashboard may support approximate real-time compliance monitoring, providing timestamps for security scans, allowing for proactive monitoring for non-compliance. The centralized dashboard may provide an organization with centralized visibility of security information in a single location by linking code repositories to applications, and presenting metrics at the business unit level. The centralized dashboard may also provide advantages due to automation and consistency. For example, the centralized dashboard may automate the collection of security information, which may allow for consistent and reliable security scanning and gating for applications (relative to error-prone manual methods). Additionally, or alternatively, the compliance dashboard may support audit preparedness, allowing an organization streamlined access to up-to-date security and compliance information for all applications in a single location, which may reduce the time needed to perform audits.

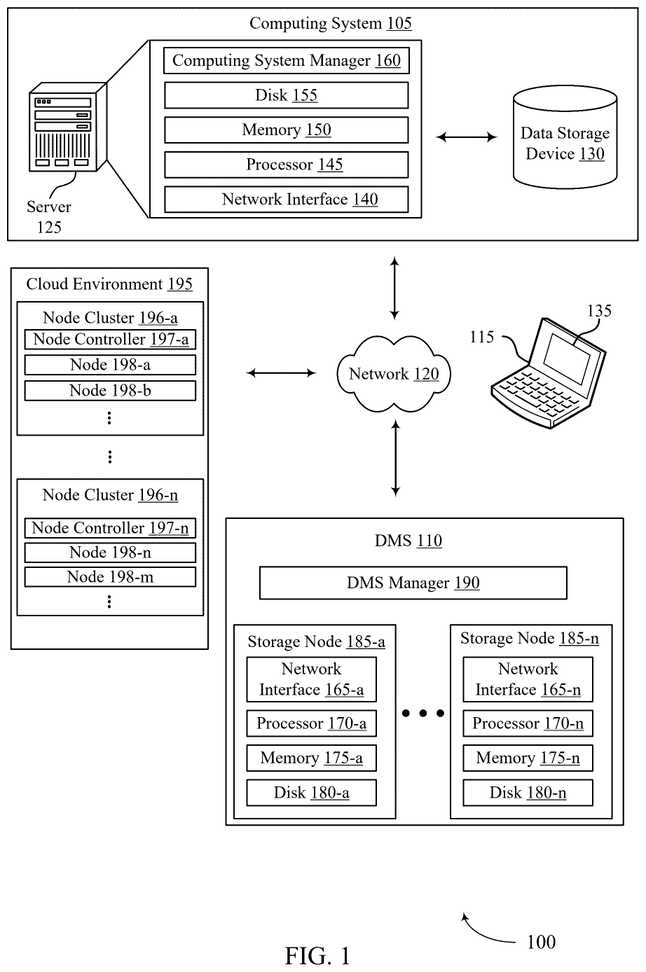

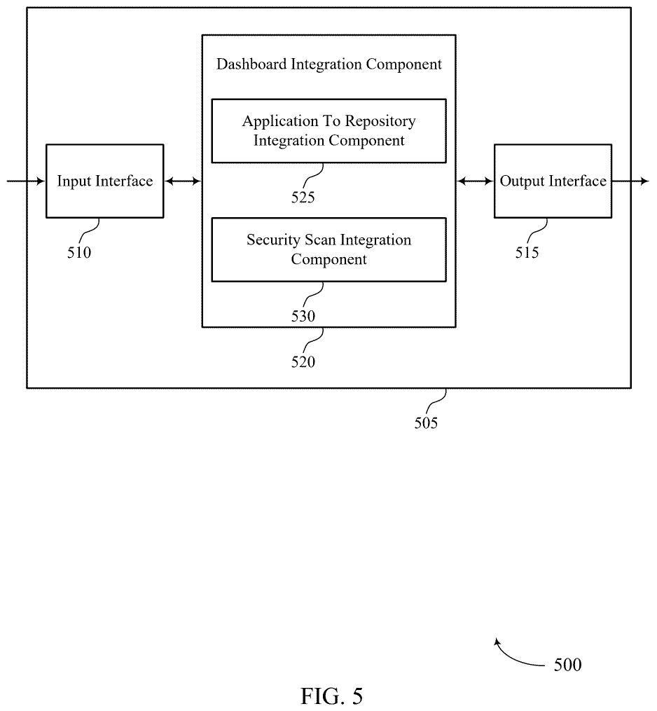

Aspects of the disclosure are initially described in the context of systems, user interfaces, application compliance monitoring flows, and process flows with reference to FIGS. 1 through 4. Aspects of the disclosure are further illustrated by and described with reference to block diagrams, systems and flowcharts that relate to techniques for verifying a sender identity using a user-generated identifier with reference to FIGS. 5 through 9.

This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

It should be appreciated by a person skilled in the art that one or more aspects of the disclosure may be implemented in a system to additionally, or alternatively, solve other problems than those described herein. Further, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

FIG. 1 illustrates an example of a computing environment 100 that supports compliance monitoring techniques for multiple applications in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may support one or more different software releases, a data store including storage of one or more code repositories, a data classification and storage service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display, such as via a user interface 135) data or other information received from the computing system 105, the DMS 110, or both. A user of a computing device 115 may, for example, use the computing device 115 to interact with one or more user interfaces (e.g., graphical user interfaces (GUIs), centralized user interfaces, each of which may be examples of the user interface 135) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may function as an application server or a file server. In general, a server 125 may refer to one or more hardware devices that function as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, where shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes (e.g., storage node 185-a through storage node 185-n). The DMS manager 190 may manage operation of the DMS 110, including the storage node 185-a through storage node 185-n. Though illustrated as a separate entity within the DMS 110, the DMS manager 190 may in some cases be implemented (e.g., as a software application) by one or more of the storage nodes. In some examples, the storage nodes may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes of the DMS 110 may include respective network interfaces (e.g., network interface 165-a through network interface 165-n), processors (e.g., processor 170-a through processor 170-n), memories (e.g., memory 175-a through memory 175-n), and disks (e.g., disk 180-a through disk 180-n). The network interfaces may enable the storage nodes to connect to one another, to the network 120, or both. A network interface may include one or more wireless network interfaces, one or more wired network interfaces, or any combination thereof. The processor of a storage node may execute computer-readable instructions stored in the memory of the storage node to cause the storage node to perform processes described herein as performed by the storage node. A processor may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk may include one or more HDDs, one or more SDDs, or any combination thereof. Memories and disks may comprise hardware storage devices. Collectively, the storage nodes may in some cases be referred to as a storage cluster or as a cluster of storage nodes.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster (e.g., node cluster 196-a through node cluster 196-n) across which data (e.g., data management data, metadata for data management data, among other examples) for a customer or tenant is stored. Each node cluster may include a node controller (e.g., node controller 197-a through node controller 197-n) which manages the nodes of the node cluster (e.g., node 198-a, node 198-b, through node 198-n, node 198-m). As an example, a node cluster for one tenant or customer may be hosted on Microsoft Azure, and another node cluster may be hosted on Amazon Web Services. In another example, multiple separate node clusters for multiple different customers or tenants may be hosted on Microsoft Azure. Separating each customer or tenant's data into separate node clusters provides fault isolation for the different customers or tenants and provides security by limiting access to data for each customer or tenant.

In some aspects, the DMS 110 may support the integration of various aspects of the present disclosure with one or more artificial intelligence (AI) systems that have been developed to mimic human-level intelligence, which may be deployed to support various processes such as task automation, decision-making optimizations, content generation, among other examples, all while supporting innovation across fields like healthcare, technology, education, finance, and others. Such AI systems may support ongoing learning, including ongoing adaptations and optimizations based on assigned tasks. AI technology may include various different sub-technologies such as machine learning (for example, deep learning) and elementary technology utilizing machine learning. Machine learning may include one or more algorithms that classify data and adaptively learns the features of input data. Elementary technology may include technologies that mimic cognitive functions, such as recognition and judgment of the human brain, using a machine learning algorithm such as deep learning, consisting of technical fields including linguistic understanding, visual understanding, inference and/or prediction modeling, knowledge presentation, operation control, among other aspects.

The DMS 110 may provide services to support proper compliance with various standards, including cybersecurity and software standards tailored to specific industries. For example, the DMS 110 may support a financial institution which may be in compliance with various data security standards mandated for financial industries, along with other individual standards set by individual financial organizations. For example, the DMS 110 may support enforcement and compliance with standards set in place by various different standards bodies, such as the National Institute of Standards and Technology (NIST), the Federal Financial Institutions Examination Council (FFIEC), and the Federal Reserve Board (FRB), which may collectively contribute to the establishment of standards than impact information security, encryption, and financial institution practices.

In some implementations, the DMS 110 may support compliance of software and computing systems with various NIST standards, or other federally enforced or implemented standards. For example, NIST is a United States-specific federal agency that develops and promotes measurement standards, although the DMS 110 may support compliance of software and computing systems for other non-United States-based agencies. Some example standards may include software standards, computing standards, cybersecurity standards, and other organizational standards.

In some examples, an organization may comply with Federal Information Processing Standards (FIPS), which may establish security and interoperability standards for computer systems utilized by a government (such as by the United States government). In some aspects, FIPS may apply to encryption algorithms, key management, and security for hash functions, among other security standards. Additionally, or alternatively, an organization may comply with NIST special publications (SP) that provide guidelines, best practices, and recommendations for various aspects of information security and software development. For example, some such publications may include security and privacy controls for federal information systems and organizations, protections for controlled unclassified information in nonfederal systems and organizations, among other publications. Additionally, or alternatively, an organization may comply with a cybersecurity frameworks that may help manage and improve cybersecurity protocols for the organization by providing a set of guidelines and best practices for identifying, protecting, detecting, responding to, and recovering from cybersecurity incidents. Additionally, or alternatively, an organization may comply with a risk management framework (RMF), which may include a set of guidelines for managing information security risk in federal information systems. In some aspects, the RMF may provide a structured process for organizations to assess and manage risk throughout the system development life cycle. An organization may comply with a secure software development framework, which may support secure software development practices, including guidelines for integrating security into the software development life cycle, implementation of secure coding practices, and integration of vulnerability management processes. In some examples, vulnerability management processes may include integration of a common vulnerability scoring system (CVSS), which may include a standardized framework for assessing and scoring the severity of software vulnerabilities such that the organization may effectively prioritize and address security vulnerabilities. Additionally, or alternatively, an organization may receive software assurance guidance that may support building of secure and reliable software, including support for secure coding practices and tools for assessing and improving software security.

In some implementations, the DMS 110 may support compliance of software and computing systems with various FFIEC standards. For example, FFIEC may set various compliance standards for financial institutions to ensure the security and resilience of information systems. In some examples, an organization may comply with information security standards, including compliance with various guidelines for implementing and maintaining effective information security programs, with an emphasis on protective sensitive financial information and financial data from unauthorized access. Such security programs may support data confidentiality, integrity, and availability. Additionally, or alternatively, an organization may comply with various risk management standards and robust risk management practices to identify, assess, and mitigate risks associated with information security, technology, and business operations. Additionally, or alternatively, an organization may comply with various access control standards, which may control and manage access to information systems and sensitive data, allowing only authorized individuals to gain access to appropriate resources (e.g., based on roles and responsibilities of the individuals).

Additionally, or alternatively, an organization may comply with various incident response and resilience standards, including guidelines for developing and maintaining comprehensive and robust incident response plans, including an emphasis on abilities to detect, respond to, and recover from cybersecurity incidents (e.g., data breaches, ransomware attacks, among other incidents). In some examples, an organization may also (or alternatively) comply with business continuity planning standards, which may allow for maintaining business continuity to insure the availability of critical systems and services during disruptions or disasters. Additionally, or alternatively, an organization may comply with various secure software development practices including secure coding practices in the development and maintenance of software systems (e.g., for financial institutions or other institutions). In some cases, an organization may comply with various standards for managing and mitigating risks associated with third-party service providers, with an emphasis on due-diligence and ongoing security monitoring. An organization may comply with training and awareness standards, including guidelines for providing training and awareness programs to employees to enhance understanding of information security risks and best practices. Additionally, or alternatively, an organization may comply with various compliance assessment standards, which include compliance with expectations for financial institutions to conduct regular assessments to ensure compliance with FFIEC guidelines and address any identified deficiencies.

Collectively, standards may impact the development, upkeep, and ongoing security protocol implementation of software systems. An organization may be tasked with ensuring compliance with the guidelines, standards, and recommendations from state and federal agencies, including NIST, FFIEC, and/or FIPS, while also engaging in collaboration with regulatory entities like FRB. Such compliance ensures the establishment of robust cybersecurity measures, compliance with regulatory obligations, and safeguarding sensitive information against diverse threats, especially when the organization stores and utilizes large amounts of sensitive data. Regular compliance assessments, often carried out through regulatory examinations, validate the adherence of an organization to these standards, preserving the integrity and security of implemented systems.

A DMS 110 may support performing various system scans to ensure compliance of applications (including code repositories associated with the applications) to various standards, including security standards and other compliance monitoring processes for the applications. In some aspects, the DMS 110 may include one or more code repositories, which may be a storage location for code and other software development assets, such as documentation, tests, scripts, or any combination thereof. In some aspects, a code repository may be used to manage and organize a software codebase associated with an application and may be used as a collaboration platform between developers of an application. A code repository may be hosted at one or more locations, including local storage on a server, at a network-attached storage (NAS) device, remotely in the cloud, or any combination thereof. By using the code repository, software and application developers may track and manage changes made to a codebase (and may roll back to previous versions if needed).

In some aspects, an organization may have multiple applications that are monitored for security and compliance with different standards. Some processes of manually identifying and monitoring security measures and compliance across diverse code repositories associated with multiple applications may be time-intensive and inefficient. To more effectively manage applications and ensure compliance of applications to security standards, a system may support a user interface 135 that includes a dashboard that automates the collection of security information, links code repositories to applications, and providing real-time insights into security measures for each application represented by the user interface.

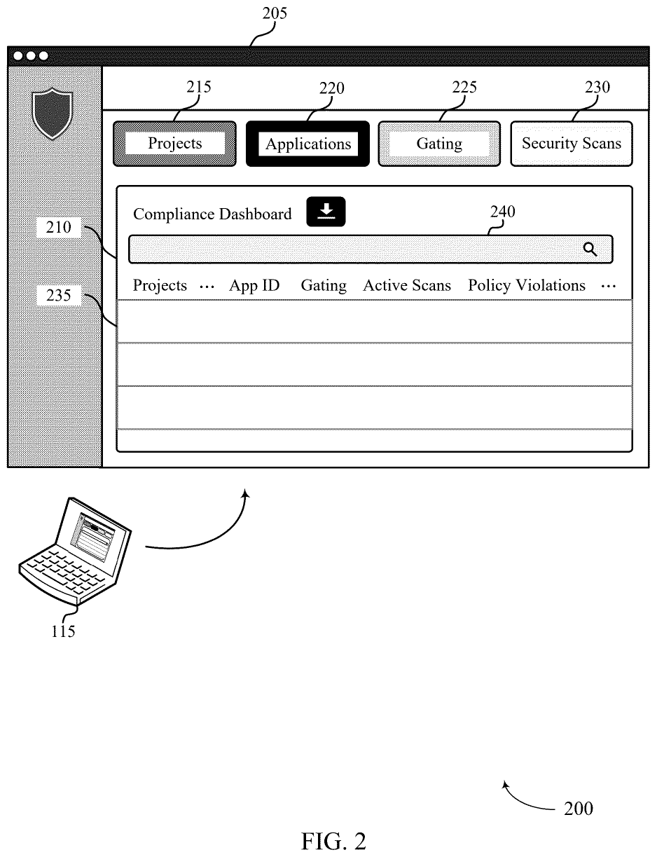

FIG. 2 shows an example of a user interface 200 that supports compliance monitoring techniques for multiple applications in accordance with aspects of the present disclosure. For example, the user interface 200 may include a unified platform 205 including a centralized dashboard 210 that illustrates a set of applications associated with an organization, or associated with an individual, where the set of applications are subject to various security checks and standards compliance measures.

An organization may host, support, or run a set of applications or projects, each of which may be subject to stringent security metrics, and compliance checks to ensure that each of the applications is up to the latest security standards. Some organizations may have a relatively large quantity of applications, and the organization may manually check for standards compliance for each application. In some cases, however, manually checking compliance for applications and associated code repositories is both labor and time intensive, and may be inefficient for an organization. Additionally, or alternatively, manually checking applications and associated code for compliance may be relatively less accurate than an automated or computer-centric process. Such manual review may result in unidentified vulnerabilities and out-of-compliance applications.

To increase the efficiency and accuracy in how an organization manages the security scanning and other compliance-related checks for applications, the organization may utilized a centralized dashboard 210 that automates the collection and presentation of security scan and gating information (e.g., information regarding whether a security check has failed, whether a warning or an alert is issued, or the like) for applications within an organization. This centralized dashboard 210 may link each code repository to a corresponding application (e.g., via application identifier (ID)), which may provide details about code repository ownership, associated business units, and the level of security gating implemented for a given application. Additionally, the centralized dashboard 210 may display information on whether security scans are enabled for a code repository and timestamps of when such security scans were last conducted. In some aspects, the centralized dashboard 210 may display comprehensive application security metrics at a business unit level across the entire company, so that applications may be monitored, scanned, and maintained in real time. The centralized dashboard 210 may additionally, or alternatively, provide increased visibility into the most up-to-date security status of applications, which may allow an organization to have easier access to security information, and more effectively and promptly address any non-compliant applications, providing support for timely security scans and implementing consistent security gating measures for applications that are found to be non-compliant.

In some examples, the centralized dashboard 210 may implement automation (e.g., automation of security checks and automation of the display of security information) and centralization (e.g., display of real-time security scan information in a single location at the centralized dashboard 210). The centralized dashboard 210 provides a single location that an organization or user can view to check the status of multiple applications, rather than manually navigating multiple code repositories to check for compliance of the associated applications. That is, the centralized dashboard 210 may streamline application security status into a single platform, including various customizable settings for effective viewing of different aspects of application status. For example, the centralized dashboard may support establishment of direct connections between code repositories and applications, offering (approximate) real-time compliance monitoring through timestamps (supporting proactive and timely security checks and compliance monitoring), and aggregated security metrics. In such examples, the centralized dashboard 210 may eliminate extensive manual efforts (which may be time consuming and error-prone), and may significantly accelerate review and audit processes for applications.

For example, the use of the centralized dashboard 210 may reduce the audit time for an organizations applications (e.g., from weeks to minutes or seconds) based on the centralization of security scan information to single location at the centralized dashboard 210. Some audit techniques, that is, require gathering audit information for applications across various different code repositories, which may be time consuming and error prone. The centralized dashboard 210, however, may link together each application with associated code repositories, and may display security scan information in a single location (rather than multiple different locations), which may significantly reduce audit time and increase audit efficiency. The automation and centralization of security information across all applications of an organization to the centralized dashboard 210 may allow for improved security and centralized visibility for applications, improved efficiency for developers, reduced audit time, and approximate real-time compliance monitoring for applications.

The centralized dashboard 210 may have a set of tabs that allow for visibility into different aspects of running applications. For example, the centralized dashboard 210 may have a projects tab 215, an applications tab 220, a gating tab 225, a security scans tab 230, among other possible tabs. In some examples, the projects tab 215 may display a total quantity of projects ongoing for an organization or a user, the applications tab 220 may display a total quantity of applications for the organization or user, the gating tab 225 may display a total quantity of gating procedures associated with applications (e.g., how may applications are in need of a security scan, or how many applications may be flagged with a gating tag or another compliance policy restriction), and the security scans tab 230 may display a total quantity of security scans performed, initiated, or in progress.

Each line 235 of the centralized dashboard 210 may include information such as a project name, the manager of the application, the chief information officer (CIO) associated with the application, a business use or business department using the application, the application ID, any gating information associated with the application, a quantity of security scans associated with the application, and any policy violations associated with the application. In some aspects, the line 235 may have color-coded, highlighted, or other visible markings that indicate different kinds of compliance statuses. For example, if an application is out of compliance (or in need of an updated security scan), the application may be highlighted to indicate a task (such as a security scan) for completion. In some examples, the centralized dashboard 210 may include a search bar 240 which may allow for an application search. For example, a user may input one or more key phrases, an application ID, or other information associated with an application, and the centralized dashboard 210 may return the most relevant applications based on the input search.

In some examples, a user may access additional information regarding individual applications, and may modify various metrics allowed for individual applications. For example, a user may access different risk profiles associated with each individual application, which may include a profile of inherent risk associated with the application (e.g., high risk, medium-high risk, medium-low risk, and low risk). In some examples, the risk profile may include whether critical vulnerabilities are allowed, whether high vulnerabilities are allowed, whether medium vulnerabilities are allowed, and/or whether low vulnerabilities are allowed for an application. In some examples, the centralized dashboard 210 may automatically check an application (or may perform scans for an application) based on a compliance policy associated with the application. For example, various scans such as static application security testing (SAST) scans, dynamic application security testing (DAST) scans, dependency scanning, and secret detection scans, among other scans, may be enabled or disabled by a user for a given application, based on a compliance policy for the application.

It should be noted that the tabs and information illustrated at the user interface 200 may be examples, and the user interface 200 and the centralized dashboard 210 may not be limited to the examples described herein.

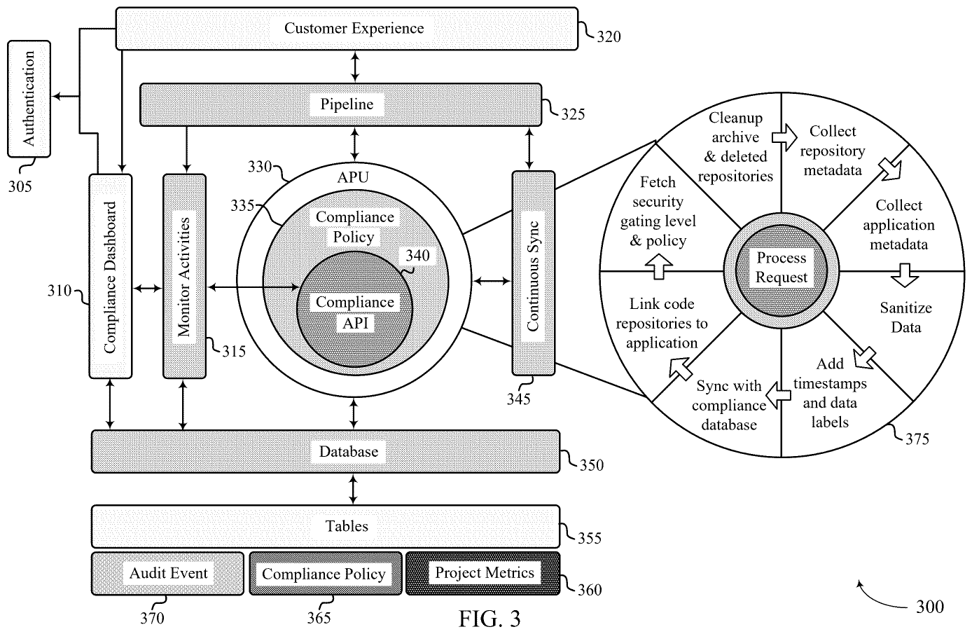

FIG. 3 shows an example of an application compliance monitoring flow 300 that supports compliance monitoring techniques for multiple applications in accordance with aspects of the present disclosure. For example, the application compliance monitoring flow 300 may include a compliance dashboard 310, which may be an example of a centralized dashboard 210 described with reference to FIG. 2.

The application compliance monitoring flow 300 may include an authentication step 305, which may connect an application (in any coding language or on any stack) to an authentication process which defines how a user may sign in to access applications and the compliance dashboard 310. Each time a user tries to authenticate, the authentication step 305 may verify the identity of the user and may send the authentication information to the associated applications.

The compliance dashboard 310 may include a display of various applications and associated compliance information for each application (or selected applications) for an organization. In some aspects, the compliance dashboard 310 may be in communication with a monitor activities component 315, which may monitor activities for applications, such as security scan activities, or other compliance update activities. In some examples, the compliance dashboard 310 may be associated with a customer experience interface 320, which may provide a user interface including display for the compliance dashboard 310.

The customer experience interface 320, the compliance dashboard 310, and the monitor activities component 315 may be in communication with a pipeline 325, which may be a software development pipeline that supports storage, maintenance, and development of software associated with the applications included in the compliance dashboard 310. In some examples, the pipeline may be hosted by a software development platform (e.g., GitLab). In some examples, the pipeline may be an example of a continuous integration and continuous deployment (CI/CD) pipeline (which may also be referred to as a continuous integration/continuous delivery pipeline or other similar terminology), which may automate software development workflows to allow for the development and deployment of high quality code. The CI/CD pipeline may support a continuous and iterative process to build, test, and deploy software (and software updates) such that the need for manual intervention and avoids bugs and code failures may be minimized or reduced. The implementation of a CI/CD pipeline may allow for relatively faster automatic detection of issues or bugs present in code as it is being developed, which reduces the likelihood of expensive and time-consuming fixes later in development. The use of a CI/CD pipeline may also allow institutions to create, test, and automatically deploy software features with minimal manual intervention. In addition, various features to check developed code may be integrated into the CI/CD pipeline. After checks of the code are preformed, the code may be deployed to various environments including a quality assurance stage, staging, and production environments. The CI/CD pipeline may also allow for rapid rollback of changes, for example, in the event that new features cause challenges with existing software, the CI/CD pipeline may allow developers to immediately return the software to a previous state, and rapidly implement fixes. In some implementations, an organization may apply compliance policies and gating procedures (e.g., based on applications that are in need of a security scan, or how many applications may be flagged with a gating tag or another compliance policy restriction) to aspects of software development such as application testing prior to roll-out.

The customer experience interface 320, the compliance dashboard 310, the monitor activities component 315, and the pipeline 325 may be in communication with an accelerated processing unit (APU) 330 (including a combination of a CPU and a GPU) that stores a compliance policy 335 as part of a compliance API 340. In some examples, the compliance policy may be a pipeline compliance policy that may include various compliance metrics defined for one or more applications. For example, the compliance policy 335 may include components approved for use in the pipeline 325 (e.g., artifacts, dependencies libraries, images, among other components), security scans indicated for use in the pipeline (e.g., SAST, DAST, dependency scans, secret detection scans), and types of vulnerabilities that may be considered as a policy violation (e.g., whether a critical vulnerability, a high vulnerability, a medium-high vulnerability, or a medium vulnerability is considered to be a violation, based on the security standards set in place for an application). Additionally, or alternatively, the compliance policy 335 may include pipeline gating actions based on development lifecycle stage (e.g., pre-release, release) and associated policy violations (e.g., policy violation warning, compliance policy fail, compliance policy violation alert, among other possible policy statuses), and a set of violation remediation deadlines associated with an application (e.g., a threshold period of time that policy violations should be remedied, such as 30 days, 60 days, 90 days, and so on). In some examples, an organization may support the use of one or more AI-based techniques in various remediation workflows. For example, an AI model/functionality may be invoked to analyze policy violations, and may perform remediation based on the identification of policy violations. In some aspects, the implementation of AI may allow for automated remediation based on identification of one or more policy violations, based on the violation remediation deadlines, or both. In some aspects, the AI model/functionality may explain (e.g., generate text or other form of explanation) compliance violations using augmented pre-defined violation verbiage with additional scenario-specific insights. Additionally, or alternatively, the AI model/functionality may propose application changes to resolve compliance violations, and may automatically and iteratively remediate compliance violations. Additionally, or alternatively, the AI model/functionality may be used to identify one or more compliance violation trends, which may be used to refine software development processes and reduce compliance violations over time. In some examples, the compliance policy 335 may be evaluated and applied during execution of the pipeline 325. In some examples, the compliance policy 335 may vary according to risk ratings of the application running in the pipeline 325 (e.g., a high security application may utilize a stringent compliance policy, where a relatively lower security application may utilize a relaxed compliance policy).

In some implementations, the application compliance monitoring flow 300 may implement an exception flow (e.g., break glass) which may allow the pipeline 325 to bypass compliance policy restrictions (e.g., gating restrictions) and proceed to production. For example, the exception flow may be initiated via a self-service interface (e.g., initiated by a user), and may include an automatic expiration of the exception after a defined period of time (e.g., a quantity of hours, minutes, or days), after a threshold quantity of pipeline execution, safter the exception flow is stopped (e.g., after a user disables the exception flow, such as when a user manually and/or explicitly expire or disable the exception flow at some time), or any combination thereof.

In some implementations, the application compliance monitoring flow 300 may provide continuous synchronization 345 for the compliance API 340, the compliance policy 335, the APU 330, the pipeline 325, the monitor activities component 315, and the compliance dashboard 310. For example, the continuous synchronization 345 may provide continuously updated information regarding compliance of applications to the compliance dashboard 310. The application compliance monitoring flow 300 may additionally include a database 350, which may include a storage of table 355, including project metrics 360, a set of compliance policies 365, and audit events 370.

In some examples, a user may prompt the compliance API 340 (e.g., via the compliance dashboard 310) with one or more requests for information (e.g., compliance or security scan information for an application and associated code repository, gating information, among other requests), which may initiate the process request flow 375. At a first step, the process request flow 375 may cleanup any archive and deleted code repositories. The process request flow 375 may then collect repository metadata from the pipeline 325, and may collect application metadata from a platform (e.g., a cloud platform such as ServiceNow). The process request flow 375 may then sanitize the metadata and add timestamps and other data labels to the collected data. The process request flow 375 may then sync the collected data with the compliance database and may link the code repositories to respective applications, and may fetch security gating level and policy information for the respective applications. The information may then be delivered via the compliance dashboard 310 responsive to the request.

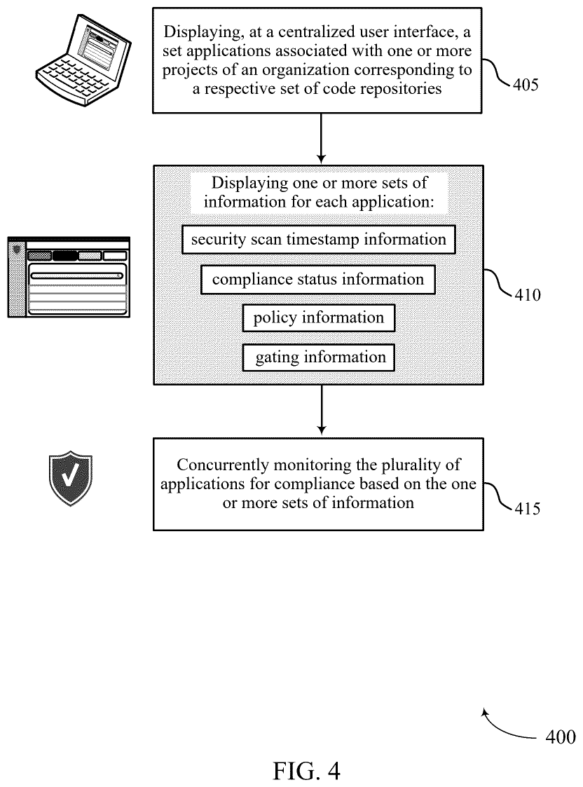

FIG. 4 shows an example of a process flow 400 that supports compliance monitoring techniques for multiple applications in accordance with aspects of the present disclosure. For example, the process flow 400 may support integration of compliance scanning and compliance checks for applications and corresponding code repositories, which may be displayed in a single user interface.

In the following description of process flow 400, the operations may be performed in a different order than the order shown, or other operations may be added or removed from the process flow 400. For example, some operations may also be left out of process flow 400, may be performed in different orders or at different times, or other operations may be added to process flow 400. Actions of the process flow 400 may be performed at or by one or more devices or operators.

At 405, a device (such as a computing device 115 described herein) may display, at a centralized user interface, a set of applications (e.g., one or more applications) associated with one or more projects of an organization. In some aspects, the set of applications may correspond to a respective set of code repositories. In some examples, displaying the one or more sets of information associated with each application may include monitoring the respective set of code repositories associated with the set of applications, and displaying the security timestamp information, the compliance status information, the policy information, the gating information, or any combination thereof, for each application.

At 410, the device may display, for each application of the set of applications at the centralized user interface, one or more sets of information associated with each application. For example, the one or more sets of information may include security scan timestamp information, compliance status information, policy information, gating information, or any combination thereof, for each application of the set of applications. In some examples, the respective set of code repositories may be scanned for data associated with the one or more sets of information, wherein the scanning occurs in accordance with a scanning interval (e.g., a dynamically adjustable scanning interval or a fixed scanning interval). In some examples, the security scan timestamp information, the compliance status information, the policy information, the gating information, or any combination thereof, may be indicative of real-time (e.g., up-to-date) data compiled for the security scan timestamp information, the compliance status information, the policy information, the gating information, or any combination thereof. For example, the centralized user interface may be in communication with an API to access a database associated with the set of applications and the respective set of code repositories associated with the set of applications. In some aspects, the communication between the centralized user interface and the API may allow for continuous updates to the information displayed at the centralized user interface.

In some examples, the compliance status information may include information associated with a compliance policy of a pipeline, where the compliance policy indicates a set of components approved for use in the pipeline, a set of pipeline-specific security scans to be executed, a threshold vulnerability metric indicative of one or more policy violations, a set of pipeline gating actions that are based at least in part on development lifecycle stage of the pipeline, policy violations, or both, or a set of policy violation remediation deadlines associated with the compliance policy. In some aspects, the centralized user interface may display a timestamp that indicates a time since the one or more sets of information were last updated (which may allow a user to determine whether the application is out of compliance or otherwise should be updated).

At 415, the set of applications may be concurrently monitored for compliance to various standards based on the one or more sets of information. In some examples, the concurrent monitoring of the applications may include determining, in accordance with the information displayed at the centralized user interface, that one or more applications is out of compliance based on the security scan timestamp information indicating a last scan time that exceeds a security scan frequency threshold. In some examples, the scan frequency may vary across applications and may be based on risk profiles associated with respective applications (e.g., business criticality risks, internal risk vs. external risks, among other risk types). Based on the expiration of the latest scan time and determining that the one or more applications are out of compliance, one or more remedial actions may be triggered for the one or more applications (e.g., to bring the one or more applications into compliance). In some cases, the remedial action may include triggering a security scan for the one or more applications based on the last scan time exceeding the security scan frequency threshold.

In some other examples, the concurrent monitoring of the applications may include determining, in accordance with the information displayed at the centralized user interface, that one or more applications is out of compliance based on the policy information indicating at least one policy violation for the one or more applications. Based on the policy violation and based on determining that the one or more applications are out of compliance, one or more remedial actions may be triggered for the one or more applications (e.g., to bring the one or more applications into compliance). In some cases, the remedial action may include triggering a security scan for the one or more applications based on the at least one policy violation.

In some other examples, the concurrent monitoring of the applications may include determining that the one or more applications are out of compliance. In some cases, an exception flow may be triggered to bypass one or more remedial actions. In some such cases, the exception flow may expire after a threshold duration (e.g., the exception flow may be valid for a certain period of time), or may expire after a threshold quantity of pipeline executions, after a user disables the exception flow, or any combination thereof. For example, a user may manually or explicitly expire (e.g., disable) the exception flow at any time.

In some examples, a user may provide, via one or more input fields of the centralized user interface, one or more search inputs associated with one or more applications of the set of applications. The user may then receive, via the centralized user interface, a returned list of the one or more applications based on the one or more search inputs. For example, each application may be associated with a respective application identifier displayed at the centralized user interface, which may be used for identifying, searching, or grouping respective applications.

FIG. 5 shows a block diagram 500 of a system 505 that supports compliance monitoring techniques for multiple applications in accordance with aspects of the present disclosure. In some examples, the system 505 may be an example of aspects of one or more components described with reference to FIG. 1, such as a DMS 110. The system 505 may include an input interface 510, an output interface 515, and a dashboard integration component 520. The system 505 may also include one or more processors. Each of these components may be in communication with one another (e.g., via one or more buses, communications links, communications interfaces, or any combination thereof).

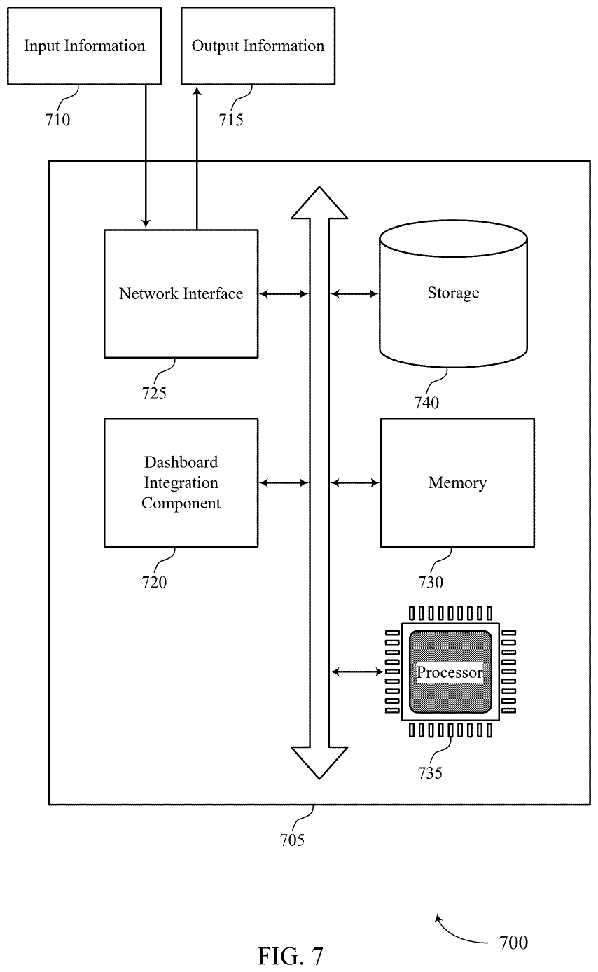

The input interface 510 may manage input signaling for the system 505. For example, the input interface 510 may receive input signaling (e.g., messages, packets, data, instructions, commands, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the dashboard integration component 520 to support compliance monitoring techniques for multiple applications. In some cases, the input interface 510 may be a component of a network interface 725 as described with reference to FIG. 7.

The output interface 515 may manage output signaling for the system 505. For example, the output interface 515 may receive signaling from other components of the system 505, such as the dashboard integration component 520, and may transmit such output signaling corresponding to (e.g., representative of or otherwise based on) such signaling to other systems or devices. In some cases, the output interface 515 may be a component of a network interface 725 as described with reference to FIG. 7.

For example, the dashboard integration component 520 may include an application to repository integration component 525 a security scan integration component 530, or any combination thereof. In some examples, the dashboard integration component 520, or various components thereof, may be configured to perform various operations (e.g., receiving, monitoring, transmitting) using or otherwise in cooperation with the input interface 510, the output interface 515, or both. For example, the dashboard integration component 520 may receive information from the input interface 510, send information to the output interface 515, or be integrated in combination with the input interface 510, the output interface 515, or both to receive information, transmit information, or perform various other operations as described herein.

The application to repository integration component 525 may be configured as or otherwise support a means for displaying, at a centralized user interface, a set of multiple applications associated with one or more projects of an organization, where the set of multiple applications correspond to a respective set of multiple code repositories. The security scan integration component 530 may be configured as or otherwise support a means for displaying, for each application of the set of multiple applications at the centralized user interface, one or more sets of information associated with each application, where the one or more sets of information include security scan timestamp information, compliance status information, policy information, gating information, or any combination thereof, for each application of the set of multiple applications. The security scan integration component 530 may be configured as or otherwise support a means for concurrently monitoring the set of multiple applications for compliance based on the one or more sets of information.

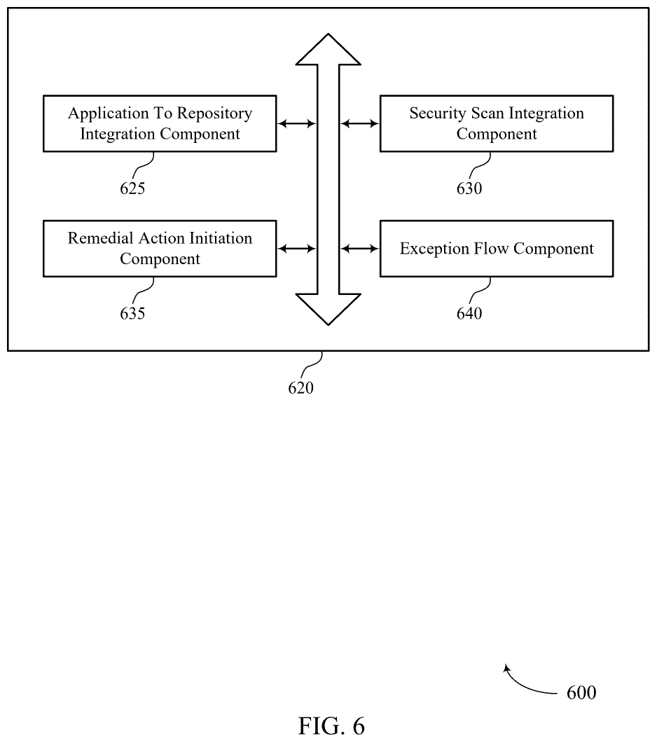

FIG. 6 shows a block diagram 600 of a dashboard integration component 620 that supports compliance monitoring techniques for multiple applications in accordance with aspects of the present disclosure. The dashboard integration component 620 may be an example of aspects of a dashboard integration component or a dashboard integration component 520, or both, as described herein. The dashboard integration component 620, or various components thereof, may be an example of means for performing various aspects of compliance monitoring techniques for multiple applications as described herein. For example, the dashboard integration component 620 may include an application to repository integration component 625, a security scan integration component 630, a remedial action initiation component 635, an exception flow component 640, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The application to repository integration component 625 may be configured as or otherwise support a means for displaying, at a centralized user interface, a set of multiple applications associated with one or more projects of an organization, where the set of multiple applications correspond to a respective set of multiple code repositories. The security scan integration component 630 may be configured as or otherwise support a means for displaying, for each application of the set of multiple applications at the centralized user interface, one or more sets of information associated with each application, where the one or more sets of information include security scan timestamp information, compliance status information, policy information, gating information, or any combination thereof, for each application of the set of multiple applications. In some examples, the security scan integration component 630 may be configured as or otherwise support a means for concurrently monitoring the set of multiple applications for compliance based on the one or more sets of information.

In some examples, to support concurrently monitoring the set of multiple applications for compliance, the security scan integration component 630 may be configured as or otherwise support a means for determining, in accordance with the one or more sets of information displayed at the centralized user interface, that one or more applications of the set of multiple applications is out of compliance based on the security scan timestamp information indicating a last scan time that exceeds a security scan frequency threshold. In some examples, to support concurrently monitoring the set of multiple applications for compliance, the remedial action initiation component 635 may be configured as or otherwise support a means for triggering one or more remedial actions for the one or more applications based on determining that the one or more applications is out of compliance.

In some examples, to support triggering the one or more remedial actions for the one or more applications, the remedial action initiation component 635 may be configured as or otherwise support a means for triggering a security scan for the one or more applications based on the last scan time exceeding the security scan frequency threshold.

In some examples, to support concurrently monitoring the set of multiple applications for compliance, the security scan integration component 630 may be configured as or otherwise support a means for determining, in accordance with the one or more sets of information displayed at the centralized user interface, that one or more applications of the set of multiple applications is out of compliance based on the policy information indicating at least one policy violation. In some examples, to support concurrently monitoring the set of multiple applications for compliance, the remedial action initiation component 635 may be configured as or otherwise support a means for triggering one or more remedial actions for the one or more applications based on determining that the one or more applications is out of compliance.

In some examples, to support triggering the one or more remedial actions for the one or more applications, the remedial action initiation component 635 may be configured as or otherwise support a means for triggering a scan for the one or more applications based on the at least one policy violation.

In some examples, to support concurrently monitoring the set of multiple applications for compliance, the security scan integration component 630 may be configured as or otherwise support a means for determining, in accordance with the one or more sets of information displayed at the centralized user interface, that one or more applications of the set of multiple applications is out of compliance. In some examples, to support concurrently monitoring the set of multiple applications for compliance, the exception flow component 640 may be configured as or otherwise support a means for triggering an exception flow to bypass one or more remedial actions.

In some examples, the exception flow expires after a threshold duration of time, after a threshold quantity of pipeline executions, after a user disables the exception flow, or any combination thereof.

In some examples, the security scan integration component 630 may be configured as or otherwise support a means for scanning the respective set of multiple code repositories for data associated with the one or more sets of information, where the scanning occurs in accordance with a scanning interval.

In some examples, the scanning interval includes a dynamically adjustable scanning interval or a fixed scanning interval.

In some examples, the compliance status information includes information associated with a compliance policy of a pipeline, the compliance policy including one or more of a set of components approved for use in the pipeline, a set of pipeline-specific security scans to be executed, a threshold vulnerability metric indicative of one or more policy violations, a set of pipeline gating actions that are based on development lifecycle stage of the pipeline, policy violations, or both, or a set of policy violation remediation deadlines associated with the compliance policy.

In some examples, to support displaying the one or more sets of information associated with each application, the application to repository integration component 625 may be configured as or otherwise support a means for monitoring the respective set of multiple code repositories associated with the set of multiple applications. In some examples, to support displaying the one or more sets of information associated with each application, the security scan integration component 630 may be configured as or otherwise support a means for displaying the security scan timestamp information, the compliance status information, the policy information, the gating information, or any combination thereof, for each application of the set of multiple applications based on monitoring the respective set of multiple code repositories associated with the set of multiple applications.

In some examples, the security scan timestamp information, the compliance status information, the policy information, the gating information, or any combination thereof, are indicative of real-time data compiled for the security scan timestamp information, the compliance status information, the policy information, the gating information, or any combination thereof.

In some examples, the application to repository integration component 625 may be configured as or otherwise support a means for providing, via one or more input fields of the centralized user interface, one or more search inputs associated with one or more applications of the set of multiple applications. In some examples, the application to repository integration component 625 may be configured as or otherwise support a means for receiving, via the centralized user interface, a returned list of the one or more applications based on the one or more search inputs.

In some examples, each application of the set of multiple applications is associated with a respective application identifier displayed at the centralized user interface.

In some examples, the application to repository integration component 625 may be configured as or otherwise support a means for displaying, at the centralized user interface, a timestamp that indicates a time since the one or more sets of information were last updated.

In some examples, the application to repository integration component 625 may be configured as or otherwise support a means for communicating, by the centralized user interface, with an application programming interface to access a database associated with the set of multiple applications and the respective set of multiple code repositories.

FIG. 7 shows a block diagram 700 of a system 705 that supports compliance monitoring techniques for multiple applications in accordance with aspects of the present disclosure. The system 705 may be an example of or include components of a system 505 as described herein. The system 705 may include components for data management, including components such as a dashboard integration component 720, an input information 710, an output information 715, a network interface 725, at least one memory 730, at least one processor 735, and a storage 740. These components may be in electronic communication or otherwise coupled with each other (e.g., operatively, communicatively, functionally, electronically, electrically; via one or more buses, communications links, communications interfaces, or any combination thereof). Additionally, the components of the system 705 may include corresponding physical components or may be implemented as corresponding virtual components (e.g., components of one or more virtual machines). In some examples, the system 705 may be an example of aspects of one or more components described with reference to FIG. 1, such as a DMS 110.

The network interface 725 may enable the system 705 to exchange information (e.g., input information 710, output information 715, or both) with other systems or devices (not shown). For example, the network interface 725 may enable the system 705 to connect to a network (e.g., a network 120 as described herein). The network interface 725 may include one or more wireless network interfaces, one or more wired network interfaces, or any combination thereof. In some examples, the network interface 725 may be an example of aspects of one or more components described with reference to FIG. 1, such as one or more network interfaces 165.

Memory 730 may include RAM, ROM, or both. The memory 730 may store computer-readable, computer-executable software including instructions that, when executed, cause the processor 735 to perform various functions described herein. In some cases, the memory 730 may contain, among other things, a basic input/output system (BIOS), which may control basic hardware or software operation such as the interaction with peripheral components or devices. In some cases, the memory 730 may be an example of aspects of one or more components described with reference to FIG. 1, such as one or more memories 175.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in a memory 730 to perform various functions (e.g., functions or tasks supporting compliance monitoring techniques for multiple applications). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. In some cases, the processor 735 may be an example of aspects of one or more components described with reference to FIG. 1, such as one or more processors 170.

Storage 740 may be configured to store data that is generated, processed, stored, or otherwise used by the system 705. In some cases, the storage 740 may include one or more HDDs, one or more SDDs, or both. In some examples, the storage 740 may be an example of a single database, a distributed database, multiple distributed databases, a data store, a data lake, or an emergency backup database. In some examples, the storage 740 may be an example of one or more components described with reference to FIG. 1, such as one or more network disks 180.

For example, the dashboard integration component 720 may be configured as or otherwise support a means for displaying, at a centralized user interface, a set of multiple applications associated with one or more projects of an organization, where the set of multiple applications correspond to a respective set of multiple code repositories. The dashboard integration component 720 may be configured as or otherwise support a means for displaying, for each application of the set of multiple applications at the centralized user interface, one or more sets of information associated with each application, where the one or more sets of information include security scan timestamp information, compliance status information, policy information, gating information, or any combination thereof, for each application of the set of multiple applications. The dashboard integration component 720 may be configured as or otherwise support a means for concurrently monitoring the set of multiple applications for compliance based on the one or more sets of information.

By including or configuring the dashboard integration component 720 in accordance with examples as described herein, the system 705 may support techniques for compliance monitoring techniques for multiple applications, which may provide one or more benefits such as, for example, improved reliability, reduced latency, improved user experience, more efficient utilization of computing resources, network resources or both, improved scalability, improved security, reduced audit time, reduced errors due to manual data collection, improved visibility to security and compliance status information for applications, real-time compliance monitoring, more timely security scanning, reduced audit time, among other possibilities.

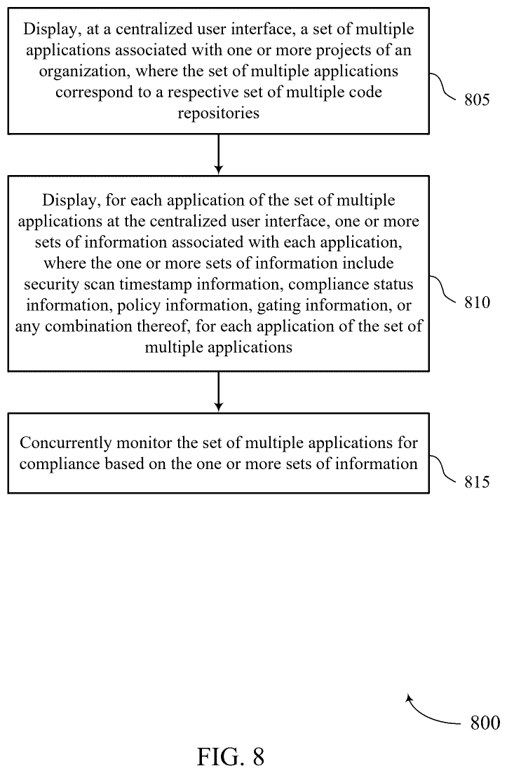

FIG. 8 shows a flowchart illustrating a method 800 that supports compliance monitoring techniques for multiple applications in accordance with aspects of the present disclosure. The operations of the method 800 may be implemented by a DMS or its components as described herein. For example, the operations of the method 800 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 805, the method may include displaying, at a centralized user interface, a set of multiple applications associated with one or more projects of an organization, where the set of multiple applications correspond to a respective set of multiple code repositories. The operations of 805 may be performed in accordance with examples as disclosed herein. In some examples, aspects of the operations of 805 may be performed by an application to repository integration component 625 as described with reference to FIG. 6.

At 810, the method may include displaying, for each application of the set of multiple applications at the centralized user interface, one or more sets of information associated with each application, where the one or more sets of information include security scan timestamp information, compliance status information, policy information, gating information, or any combination thereof, for each application of the set of multiple applications. The operations of 810 may be performed in accordance with examples as disclosed herein. In some examples, aspects of the operations of 810 may be performed by a security scan integration component 630 as described with reference to FIG. 6.

At 815, the method may include concurrently monitoring the set of multiple applications for compliance based on the one or more sets of information. The operations of 815 may be performed in accordance with examples as disclosed herein. In some examples, aspects of the operations of 815 may be performed by a security scan integration component 630 as described with reference to FIG. 6.

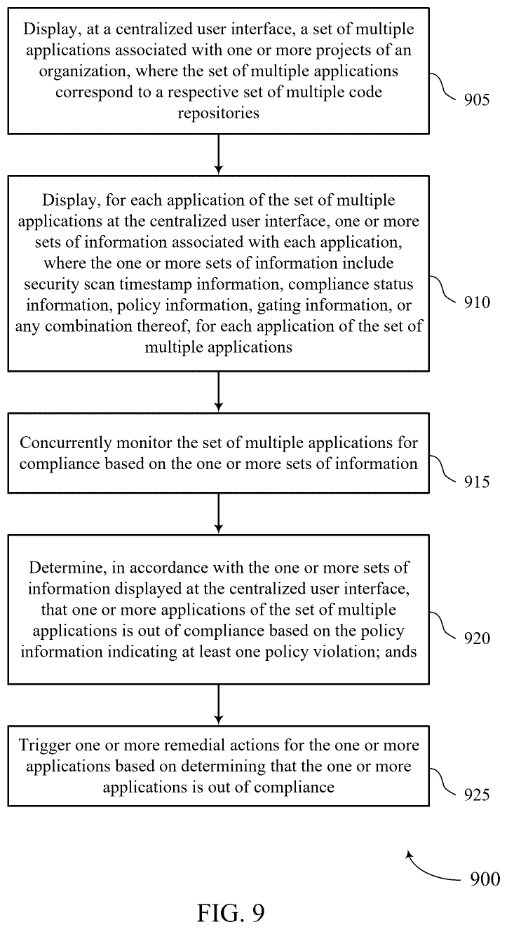

FIG. 9 shows a flowchart illustrating a method 900 that supports compliance monitoring techniques for multiple applications in accordance with aspects of the present disclosure. The operations of the method 900 may be implemented by a DMS or its components as described herein. For example, the operations of the method 900 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 905, the method may include displaying, at a centralized user interface, a set of multiple applications associated with one or more projects of an organization, where the set of multiple applications correspond to a respective set of multiple code repositories. The operations of 905 may be performed in accordance with examples as disclosed herein. In some examples, aspects of the operations of 905 may be performed by an application to repository integration component 625 as described with reference to FIG. 6.

At 910, the method may include displaying, for each application of the set of multiple applications at the centralized user interface, one or more sets of information associated with each application, where the one or more sets of information include security scan timestamp information, compliance status information, policy information, gating information, or any combination thereof, for each application of the set of multiple applications. The operations of 910 may be performed in accordance with examples as disclosed herein. In some examples, aspects of the operations of 910 may be performed by a security scan integration component 630 as described with reference to FIG. 6.

At 915, the method may include concurrently monitoring the set of multiple applications for compliance based on the one or more sets of information. The operations of 915 may be performed in accordance with examples as disclosed herein. In some examples, aspects of the operations of 915 may be performed by a security scan integration component 630 as described with reference to FIG. 6.

At 920, the method may include determining, in accordance with the one or more sets of information displayed at the centralized user interface, that one or more applications of the set of multiple applications is out of compliance based on the policy information indicating at least one policy violation. The operations of 920 may be performed in accordance with examples as disclosed herein. In some examples, aspects of the operations of 920 may be performed by a security scan integration component 630 as described with reference to FIG. 6.

At 925, the method may include triggering one or more remedial actions for the one or more applications based on determining that the one or more applications is out of compliance. The operations of 925 may be performed in accordance with examples as disclosed herein. In some examples, aspects of the operations of 925 may be performed by a remedial action initiation component 635 as described with reference to FIG. 6.

The following provides an overview of aspects of the present disclosure:
Aspect 1: A method, comprising: displaying, at a centralized user interface, a plurality of applications associated with one or more projects of an organization, wherein the plurality of applications correspond to a respective plurality of code repositories; displaying, for each application of the plurality of applications at the centralized user interface, one or more sets of information associated with each application, wherein the one or more sets of information comprise security scan timestamp information, compliance status information, policy information, gating information, or any combination thereof, for each application of the plurality of applications; and concurrently monitoring the plurality of applications for compliance based at least in part on the one or more sets of information.
Aspect 2: The method of aspect 1, wherein concurrently monitoring the plurality of applications for compliance comprises: determining, in accordance with the one or more sets of information displayed at the centralized user interface, that one or more applications of the plurality of applications is out of compliance based at least in part on the security scan timestamp information indicating a last scan time that exceeds a security scan frequency threshold; and triggering one or more remedial actions for the one or more applications based at least in part on determining that the one or more applications is out of compliance.
Aspect 3: The method of aspect 2, wherein triggering the one or more remedial actions for the one or more applications comprises: triggering a security scan for the one or more applications based at least in part on the last scan time exceeding the security scan frequency threshold.
Aspect 4: The method of any of aspects 1 through 3, wherein concurrently monitoring the plurality of applications for compliance comprises: determining, in accordance with the one or more sets of information displayed at the centralized user interface, that one or more applications of the plurality of applications is out of compliance based at least in part on the policy information indicating at least one policy violation; and triggering one or more remedial actions for the one or more applications based at least in part on determining that the one or more applications is out of compliance.
Aspect 5: The method of aspect 4, wherein triggering the one or more remedial actions for the one or more applications comprises: triggering a scan for the one or more applications based at least in part on the at least one policy violation.
Aspect 6: The method of any of aspects 1 through 5, wherein concurrently monitoring the plurality of applications for compliance comprises: determining, in accordance with the one or more sets of information displayed at the centralized user interface, that one or more applications of the plurality of applications is out of compliance; and triggering an exception flow to bypass one or more remedial actions.
Aspect 7: The method of aspect 6, wherein the exception flow expires after a threshold duration of time, after a threshold quantity of pipeline executions, after a user disables the exception flow, or any combination thereof.
Aspect 8: The method of any of aspects 1 through 7, further comprising: scanning the respective plurality of code repositories for data associated with the one or more sets of information, wherein the scanning occurs in accordance with a scanning interval.
Aspect 9: The method of aspect 8, wherein the scanning interval comprises a dynamically adjustable scanning interval or a fixed scanning interval.
Aspect 10: The method of any of aspects 1 through 9, wherein the compliance status information comprises information associated with a compliance policy of a pipeline, the compliance policy comprising one or more of a set of components approved for use in the pipeline, a set of pipeline-specific security scans to be executed, a threshold vulnerability metric indicative of one or more policy violations, a set of pipeline gating actions that are based at least in part on development lifecycle stage of the pipeline, policy violations, or both, or a set of policy violation remediation deadlines associated with the compliance policy.
Aspect 11: The method of any of aspects 1 through 10, wherein displaying the one or more sets of information associated with each application comprises: monitoring the respective plurality of code repositories associated with the plurality of applications; and displaying the security scan timestamp information, the compliance status information, the policy information, the gating information, or any combination thereof, for each application of the plurality of applications based at least in part on monitoring the respective plurality of code repositories associated with the plurality of applications.
Aspect 12: The method of any of aspects 1 through 11, wherein the security scan timestamp information, the compliance status information, the policy information, the gating information, or any combination thereof, are indicative of real-time data compiled for the security scan timestamp information, the compliance status information, the policy information, the gating information, or any combination thereof.
Aspect 13: The method of any of aspects 1 through 12, further comprising: providing, via one or more input fields of the centralized user interface, one or more search inputs associated with one or more applications of the plurality of applications; and receiving, via the centralized user interface, a returned list of the one or more applications based at least in part on the one or more search inputs.
Aspect 14: The method of any of aspects 1 through 13, wherein each application of the plurality of applications is associated with a respective application identifier displayed at the centralized user interface.
Aspect 15: The method of any of aspects 1 through 14, further comprising: displaying, at the centralized user interface, a timestamp that indicates a time since the one or more sets of information were last updated.
Aspect 16: The method of any of aspects 1 through 15, further comprising: communicating, by the centralized user interface, with an application programming interface to access a database associated with the plurality of applications and the respective plurality of code repositories
Aspect 17: An apparatus comprising one or more memories storing processor-executable code, and one or more processors coupled with the one or more memories and individually or collectively operable to execute the code to cause the apparatus to perform a method of any of aspects 1 through 16.
Aspect 18: An apparatus comprising at least one means for performing a method of any of aspects 1 through 16.
Aspect 19: A non-transitory computer-readable medium storing code the code comprising instructions executable by one or more processors to perform a method of any of aspects 1 through 16.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
displaying, at a centralized user interface, a plurality of applications associated with one or more projects of an organization, wherein the plurality of applications correspond to a respective plurality of code repositories;
displaying, for each application of the plurality of applications at the centralized user interface, one or more sets of information associated with each application, wherein the one or more sets of information comprise security scan timestamp information, compliance status information, policy information, gating information, or any combination thereof, for each application of the plurality of applications; and
concurrently monitoring the plurality of applications for compliance based at least in part on the one or more sets of information.

2. The method of claim 1, wherein concurrently monitoring the plurality of applications for compliance comprises:
determining, in accordance with the one or more sets of information displayed at the centralized user interface, that one or more applications of the plurality of applications is out of compliance based at least in part on the security scan timestamp information indicating a last scan time that exceeds a security scan frequency threshold; and
triggering one or more remedial actions for the one or more applications based at least in part on determining that the one or more applications is out of compliance.

3. The method of claim 2, wherein triggering the one or more remedial actions for the one or more applications comprises:
triggering a security scan for the one or more applications based at least in part on the last scan time exceeding the security scan frequency threshold.

4. The method of claim 1, wherein concurrently monitoring the plurality of applications for compliance comprises:
determining, in accordance with the one or more sets of information displayed at the centralized user interface, that one or more applications of the plurality of applications is out of compliance based at least in part on the policy information indicating at least one policy violation; and
triggering one or more remedial actions for the one or more applications based at least in part on determining that the one or more applications is out of compliance.

5. The method of claim 4, wherein triggering the one or more remedial actions for the one or more applications comprises:
triggering a scan for the one or more applications based at least in part on the at least one policy violation.

6. The method of claim 1, wherein concurrently monitoring the plurality of applications for compliance comprises:
determining, in accordance with the one or more sets of information displayed at the centralized user interface, that one or more applications of the plurality of applications is out of compliance; and
triggering an exception flow to bypass one or more remedial actions.

7. The method of claim 6, wherein the exception flow expires after a threshold duration of time, after a threshold quantity of pipeline executions after a user disables the exception flow, or any combination thereof.

8. The method of claim 1, further comprising:
scanning the respective plurality of code repositories for data associated with the one or more sets of information, wherein the scanning occurs in accordance with a scanning interval.

9. The method of claim 8, wherein the scanning interval comprises a dynamically adjustable scanning interval or a fixed scanning interval.

10. The method of claim 1, wherein the compliance status information comprises information associated with a compliance policy of a pipeline, the compliance policy comprising one or more of:
a set of components approved for use in the pipeline;
a set of pipeline-specific security scans to be executed;
a threshold vulnerability metric indicative of one or more policy violations;
a set of pipeline gating actions that are based at least in part on development lifecycle stage of the pipeline, policy violations, or both; or
a set of policy violation remediation deadlines associated with the compliance policy.

11. The method of claim 1, wherein displaying the one or more sets of information associated with each application comprises:
monitoring the respective plurality of code repositories associated with the plurality of applications; and
displaying the security scan timestamp information, the compliance status information, the policy information, the gating information, or any combination thereof, for each application of the plurality of applications based at least in part on monitoring the respective plurality of code repositories associated with the plurality of applications.

12. The method of claim 1, wherein the security scan timestamp information, the compliance status information, the policy information, the gating information, or any combination thereof, are indicative of real-time data compiled for the security scan timestamp information, the compliance status information, the policy information, the gating information, or any combination thereof.

13. The method of claim 1, further comprising:
providing, via one or more input fields of the centralized user interface, one or more search inputs associated with one or more applications of the plurality of applications; and
receiving, via the centralized user interface, a returned list of the one or more applications based at least in part on the one or more search inputs.

14. The method of claim 1, wherein each application of the plurality of applications is associated with a respective application identifier displayed at the centralized user interface.

15. The method of claim 1, further comprising:
displaying, at the centralized user interface, a timestamp that indicates a time since the one or more sets of information were last updated.

16. The method of claim 1, further comprising:
communicating, by the centralized user interface, with an application programming interface to access a database associated with the plurality of applications and the respective plurality of code repositories.

17. An apparatus, comprising:
one or more memories storing processor-executable code; and
one or more processors coupled with the one or more memories and individually or collectively operable to execute the code to cause the apparatus to:
display, at a centralized user interface, a plurality of applications associated with one or more projects of an organization, wherein the plurality of applications correspond to a respective plurality of code repositories;
display, for each application of the plurality of applications at the centralized user interface, one or more sets of information associated with each application, wherein the one or more sets of information comprise security scan timestamp information, compliance status information, policy information, gating information, or any combination thereof, for each application of the plurality of applications; and
concurrently monitor the plurality of applications for compliance based at least in part on the one or more sets of information.

18. The apparatus of claim 17, wherein, to concurrently monitor the plurality of applications for compliance, the one or more processors are individually or collectively operable to execute the code to cause the apparatus to:
determine, in accordance with the one or more sets of information displayed at the centralized user interface, that one or more applications of the plurality of applications is out of compliance based at least in part on the security scan timestamp information indicating a last scan time that exceeds a security scan frequency threshold; and
trigger one or more remedial actions for the one or more applications based at least in part on determining that the one or more applications is out of compliance.

19. The apparatus of claim 18, wherein, to trigger the one or more remedial actions for the one or more applications, the one or more processors are individually or collectively operable to execute the code to cause the apparatus to:
trigger a security scan for the one or more applications based at least in part on the last scan time exceeding the security scan frequency threshold.

20. A non-transitory computer-readable medium storing code, the code comprising instructions executable by one or more processors to:
display, at a centralized user interface, a plurality of applications associated with one or more projects of an organization, wherein the plurality of applications correspond to a respective plurality of code repositories;
display, for each application of the plurality of applications at the centralized user interface, one or more sets of information associated with each application, wherein the one or more sets of information comprise security scan timestamp information, compliance status information, policy information, gating information, or any combination thereof, for each application of the plurality of applications; and
concurrently monitor the plurality of applications for compliance based at least in part on the one or more sets of information.
